(19) United States
(12) Patent Application Publication
(10) Pub. No.: US 2003/0234371 A1
(43) Pub. Date: Dec. 25, 2003

(54) Device for generating reactive ions

(76) Inventor: Byron J. Ziegler, Austin, TX (US)

Correspondence Address: Byron J. Ziegler, 12341 Limerick Ave., Austin, TX, 78758, US

(21) Appl. No.: 10/465,729

(22) Filed: Jun. 19, 2003

Related U.S. Application Data
(60) Provisional application No. 60/389,992, filed on Jun. 19, 2002.

(51) Int. Cl. H01J 27/02

(52) U.S. Cl. 250/423 R; 250/424

(57) ABSTRACT

The invention relates to devices and methods for generating reactive ions in thin layer chemistry vacuum or vapor chamber where the mixture and delivery of gas to an ion source controlled by a controller sensitive to the chemical make up in the vacuum or vapor chamber.

### DESCRIPTION OF THE RELATED ART

The present invention generally relates to the application of thin film chemistry or the application of thin films to a substrate. More particularly the present invention relates devices, methods and products made with improvements to the delivery of gas to physical or chemical vacuum or vapor chambers.

### BACKGROUND

The scope of this patent is in the area of thin film chemistry with the aid of an ion source, and specifically with the mixture, feedback and regulation of gases fed into an ion source and physical or chemical vapor chamber systems.

Traditional arrangements of ion sources in such chambers are in the categories of high energy ion implantation or in low energy ions, generally limited to the use of a single gas. Other limitations include a lack of a direct feedback loop making regulation of partial gas pressures difficult and error-prone. The extent of feedback loops for ion sources in prior art has been measured with ion beam current and the overall pressure change in a gas chamber and not partial pressures of individual gases.

The proposed improvements to such a chamber system and products produced with such a chamber system would include, without limitation, the following advantages:

1. Reactive Ion Assisted Deposition (R.I.A.D.) Multilayer ion deposited materials, ion assisted chemical vapor deposition (CVD)

2. A feedback loop with a residual gas analyzer (RGA) and a programmable logic controller (PLC) can measure individual partial pressures and regulate individual valves to control pressures of individual gases within chamber.

3. Ion source can be synchronized with the movement of substrates.

4. Programmed schedule for delivery of variable gas mixes

5. Switchable channels to automate changing of gas sources, limiting down time.

6. Use of reactive gases by using inert gas dilution, reducing corrosion.

7. Repeatable runs of mixed gases based on ratios of gases using PLC control.

### BRIEF DESCRIPTION OF THE DRAWINGS

A better understanding of the present invention can be obtained when the following detailed description of various embodiments is considered in conjunction with the following drawings, in which:

FIG. 1 illustrates major components of the gas delivery system to the ion source;

FIG. 2 the relationship of the gas delivery system to the rest of the chamber and the major control system components of the gas delivery system to the ion source;

FIG. 3 illustrates a chamber with a carrier and drive system for coating multiple substrates in unison; and

FIG. 4 illustrates the chamber with carrier and drive of FIG. 3 with the substrates in different position within the chamber relative to the ion sources.

While the invention is susceptible to various modifications and alternative forms, specific embodiments thereof are shown by way of example in the drawings and are described below in greater detail. It should be understood, however, that the drawings and detailed description thereto are not intended to limit the invention to the particular form disclosed, but to the contrary, the invention is to cover all modifications, equivalents and alternatives falling within the spirit and scope of the present invention as defined by the claims.

### DESCRIPTION

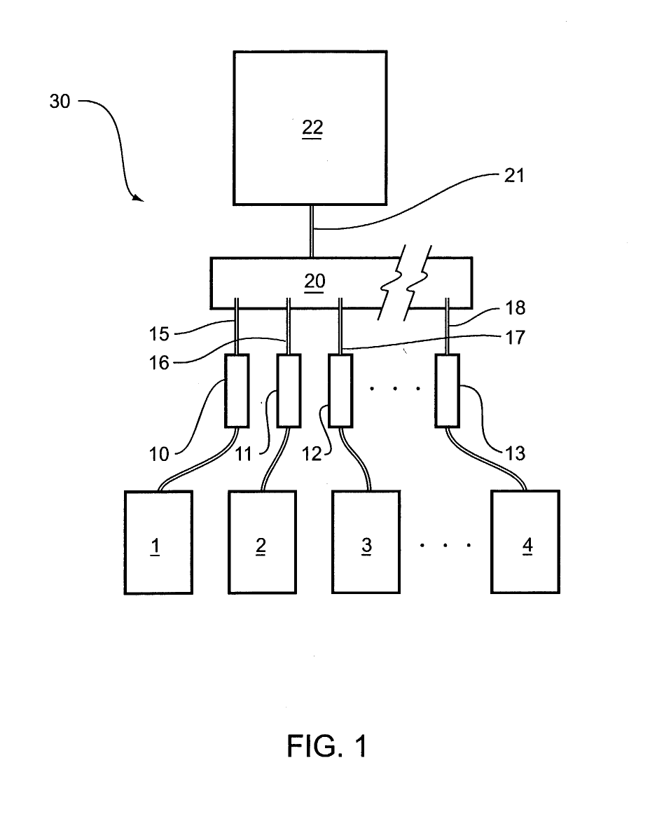

FIG. 1 illustrates major components of the gas delivery system to the ion source 22. One embodiment of the invention used a model KRI EH 1000 gridless ion source from Ion Beam Scientific. A gas or a plurality of gases are in containers, such as gas canisters or cylinders, 1, 2, 3, 4, etc. This arrangement supplies the needed gases to the fast acting valves 10, 11, 12, 13, etc.

In some embodiments, a fast-acting piezoelectric valve is used because of their fast response and precise control characteristics. An example of such a valve is the MV-112 available from Maxtek. Inc., which has a response time to an electronic control signal from a PLC (described in greater detail below) of less than 2 milliseconds, controlling a flow range of 0-500 Standard Cubic Centimeters per Minute (SCCM). Other flow ranges and response times would be suitable for different chamber systems and applications. In other embodiments, electro-mechanical solenoid valves, similar to commercial fuel-injector valves may be suitable. In yet other embodiments, mass flow controllers (MFC) such as MKS Instruments' General Purpose Mass Flow Controller Type 1179A may be suitable. It is not necessary that the valves be of the same type. In other embodiments of the invention different types of valves or flow limiting systems may be employed in different combinations. For example in one system some of the canisters' outflow may be controlled by piezoelectric valves and some of the canisters' outflow may be controlled by mass flow controllers.

The valves are connected to a manifold 20. In the embodiment shown the connection is made by means of capillary tubing 15, 16, 17, 18. It is desirable to keep the valves 10, 11, 12, 13 close to the manifold 20. A shorter distance and smaller tubing 15, 16, 17, 18 reduce the overall volume of gas between the valves 10, 11, 12, 13 and the manifold 20. In other embodiments of the invention the valves would be directly connected to the manifold. In yet other embodiments of the invention the valves would be incorporated into the manifold design which in other embodiments could also be incorporated into the body of the ion source. In some embodiments he manifold could be as simple as a junction or series of junctions of tubes at or before the ion source. In otherwords, a manifod is not strictly necessary for every embodiment of the invention. However it is desirable where more complete mixing of the gases is desired.

The gases combine in the manifold 20 and the mixture is introduced into an ion source 22. In the preferred embodiment, the manifold is designed to cause/allow turbulent mixing of the inflow gas while at the same time minimizing overall volume within the manifold. One embodiment of the invention utilizes the alloy MONEL for construction of the manifold 20. MONEL was chosen because of its resistance to corrosion.

In the embodiment illustrated in FIG. 1, the manifold 20 is connected to the ion source 22 with a small volume capillary tube 21. It is preferable though not necessary that the tube be short in length. Shorter smaller cross section tubes are desirable to minimize volumetric size of this connection to the ion source 22. The reason it is desirable to minimize the volumetric size of the system between the valves and the ion source 22 is to increase the responsiveness of the system to control. Lower volumes of gas in this portion of the system will enable the results of the control of the valves to reach the ion source 22.

The manifold is where the turbulent mixing of gas takes place. It is also desirable to achieve the minimum overall volume within the manifold in order to reduce the volume of gas between the valves and the ion source. This gives the advantage of rapid response time between the PLC's instructions and the resulting gas mixture supplied to the chamber. The volumetric characteristic of the system between the valves and ion source depends on the responsiveness necessary for the chamber system and particular application. Some of the factors that must be considered include the size of the chamber the needed gas flow rates, the responsiveness of the valves, the characteristics of the gas pumping speed/capacity, overall vacuum (negative pressure) level, etc.

The preferred manifold construction material would be the alloy, MONEL which is resistant to corrosion.

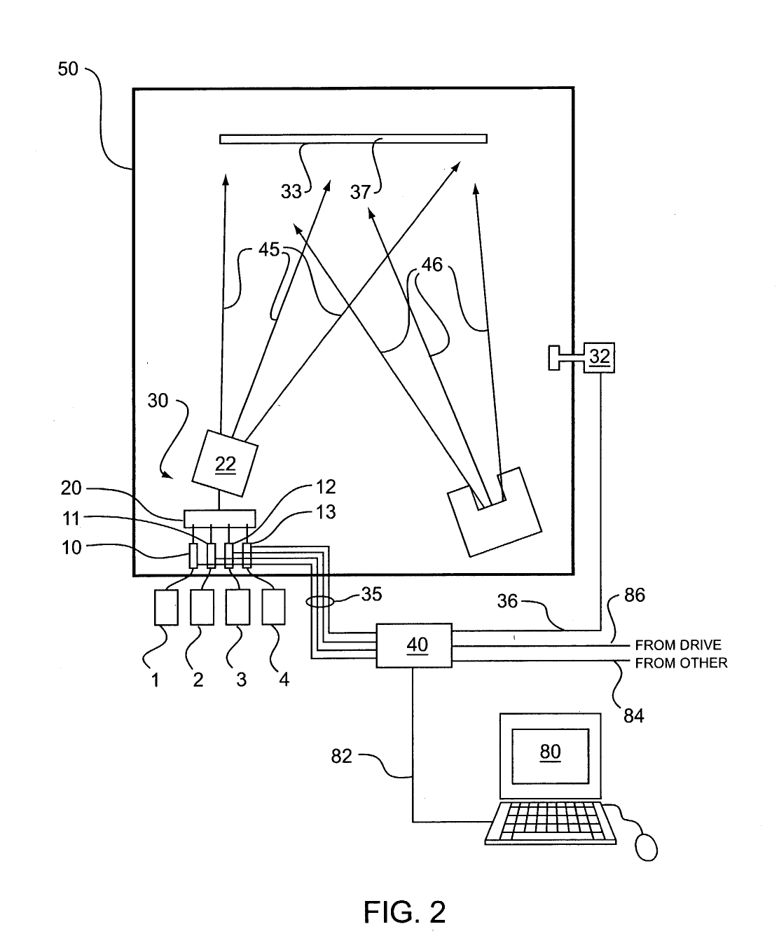

FIG. 2 illustrates the relationship of the gas delivery system 30 and its control components discussed below to the chamber 50. In the embodiment shown in FIG. 2 the gas delivery system 30 is controlled by the programmable logic controller (PLC) 40. In one embodiment of the invention, a PLC DL-405 from DirectLOGIC was found suitable. The ideal PLC will receive input signals from multiple devices and have a relatively fast output response time. The PLC 40 transmits electronic control signals to the valves 10-13 by means of communication lines 35. These signals cause the opening and closing of the valves 10-13 that deliver the gases to the manifold 20. The PLC 40 controls the rate (frequency) and duration of the opening of the valves 10-13. In alternative embodiments where the valves 10-13 can be opened in degrees, the PLC can be programmed to control the degree of opening of the valves in addition to the rate and duration.

The gas in the manifold 20 is transferred to an ion source 22. The ions 45 are then generated and released to the chamber 50. The evaporative source 31 delivers material 46 to the chamber 50. The evaporated material then reaches the surface 33 of the substrate 37. The generated ions 45 reach the substrate surface 33. The collisions of the ions 45 and the evaporative material 46 that occur on the surface 33 aid in the adherence, embedment, and densification of the evaporative material 36. In some embodiments, the reaction between the evaporated material and the ions would be a desirable result.

Meanwhile, a residual gas analyzer (RGA) 32 is constantly monitoring the partial pressures of the gases in the chamber 50. In the embodiment illustrated in FIG. 2 the residual gas analyzer 32 is a micro ion source that ionizes residual gas that is present in the chamber. The ions generated by the micro ion source are then analyzed by nine quadrupoles in an array formation. Suitable ion sources are available from Ferran Scientific—for example the Ferran Scientific Micropole. In the embodiment shown, the RGA supplies the partial gas pressure information to the PLC 40 by communication line 36. This information is utilized by the PLC 40 to make adjustments in the gas flow to reach the desired partial pressures of the individual gases. In alternative embodiments multiple RGAs 32 may be used to measure/monitor the partial pressures of different gases. In the embodiment shown, the events described are simultaneous and continuous during the length of the process. The RGA 32 and the PLC 40 and or computer 80 provide a feedback loop to the ion source 22 through valves 10, 11, 12, 13. The RGA 32 can measure individual partial pressures, provides it to the PLC 40 and/or computer 80 which controls the individual flow rates of individual gases into the chamber thus controlling the composition of energetic ions directed at the substrate in the chamber system.

In some embodiments control of gas flow would be to gas that is entered into the chamber 50 directly or in some way other than through the ion source 22.

In a typical production facility the central computer would send information to one or more vacuum deposition systems. Each chamber system would have a PLC to accept instruction for the production program. The computer/PLC system prepares for the deposition run by receiving data from multiple devices which may include the following but are not limited to; temperature (thermocouples, etc.), pressure (capacitance diaphragm gauges, etc.), partial pressures (residual gas analyzer, etc.), mechanical positioning ( motor rotation, shutter position, etc.), water flow and temperature, pumping system (cryopump, turbomolecular pump, diffusion pump), cryogenic water-trap, thermal evaporator (tungsten boat, etc.), parameters of electron beam gun (current, voltage, duration of burn, etc.), parameters of ion source (voltage potential, beam current, anode temperature, etc.) crystal monitor for deposition rate control, optical metrology of substrate and thin film coatings.

A successful production run with this information creates a history that can be repeated in future production. As the history for a particular run is accumulated the program can build from the results to make modifications for continual improvement and optimization. The logical refinement will result in higher production yields and greater profitability in manufacturing.

A typical production run would be controlled from the beginning by the PLC 40. The initial pumping of the system is accomplished with a mechanical vacuum pump followed by the start up of the cryogenic water-trap. When the pressure is low enough the PLC 40 will crossover the pumping system to a cryopump and cooling water will flow through the lines. When the pressure is low enough the RGA 32 will check the background gases and this information is sent to and analyzed by the PLC 40. If the conditions of the chamber are within the desired tolerances then the electron beam gun will fire up and the ion source will clean the substrate surface with ion bombardment. The PLC 40will monitor and control the deposition rate from the electron beam gun with the crystal monitor. The PLC 40 will monitor the information supplied by the RGA 32 and control the ion source 22 and valves 10, 11, 12, 13 and other typical system components. Data from the optical monitor will give information about the deposition on the substrate and the film quality. This will all be part of the building of history for this particular production run and can be used in the optimization of future runs with the same or improved success.

The embodiment described directly above use of PLC 40 for control. In other embodiments the PLC 40 can be used as a regulatory controller controlled by a supervisory controller, such as a computer 80, running special purpose software for controlling the processes in connection with chamber 50. In alternative embodiments the supervisory controller 80 may control the valves directly and/or receive input information directly from the RGA 32 and/or other input devices directly without the use of a PLC.

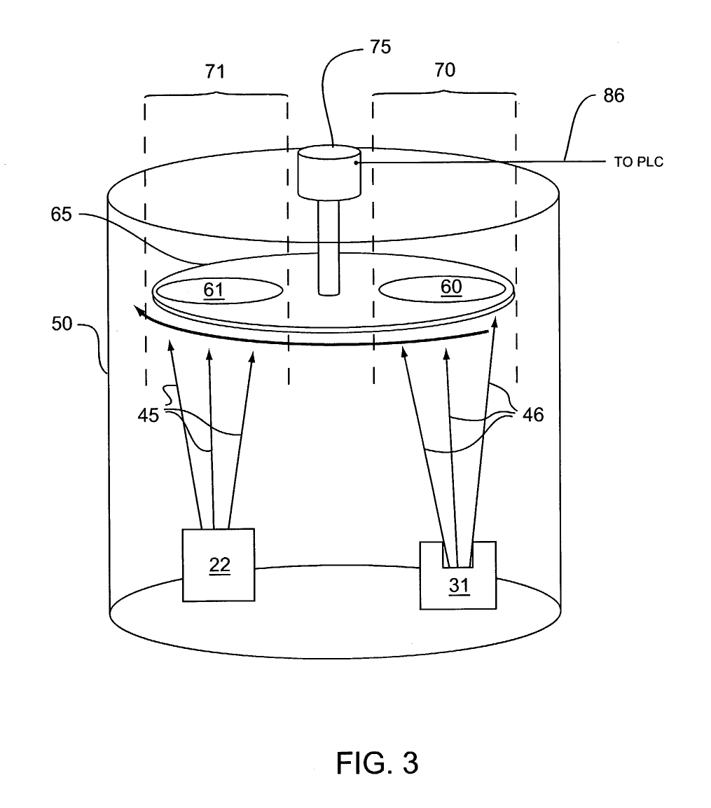

FIG. 3 illustrates the case of multiple substrates 60 61 being used with an ion source 22. The evaporative source 31 delivers material 46 to the rotating carrier 65 for the substrates 60 and 61. The rotating support 65 is driven by drive mechanism 75 which also provides position information to the PLC 40 via communications link(s) 86. The substrates must pass two general zones 70 and 71 for the completion of one revolution of the support for the substrates. During the revolution of the support, the first general zone 70 is the deposit of material 46 from the evaporative source 31 to the surface of the substrate 60.

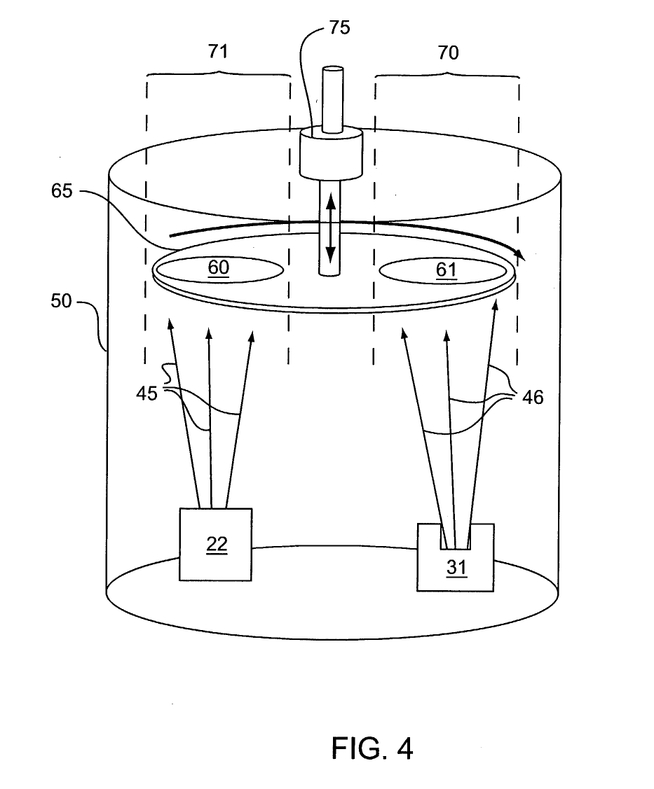

FIG. 4 illustrates the multiple substrate system of FIG. 3 with the substrates 60 61 in different positions relative to the ion source 22 and evaporative source 31. As the support rotates substrate 60 out of the deposition zone 70 (as shown in FIG. 3) into the general zone of Ion Assisted Deposition (IAD) ion bombardment 71 (as shown in FIG. 4), the ion source 22 will then deliver a burst of ions to substrate 60. After the ion burst, the ion source 22 will immediately go into a standby mode until the arrival of the next substrate 61 into zone 71 before firing the next burst of ions. This action reduces the overall average of gas load to the system and provides the benefits thereof.

In some cases the limitations of the coating chamber is the pumping mechanism (not shown) for producing high vacuum. With excessive gas in a chamber, a rise in pressure causes a shorter mean free path. The shorter mean free path results in undesirable frequent collisions and thus, a loss of particle energy. Without the delivered energy of the particles on the substrate surface, the coatings of the deposited material become porous and in the case of optical coatings, the index of refraction is variable and inconsistent.

In FIG. 3 and FIG. 4, it is shown that with proper feedback control and synchronous firing of the ion source 22, optimum conditions are able to be produced. By delivering to the system the minimum amount of ions to produce the maximum work, the operation can be optimized to produce quality coatings more efficiently. Proper feedback, synchronous firing of the ion source, and the substrate position relative to the firing ion source will be such that less of the ions from the ion source will be wasted by not being applied to the substrate. This is desirable because any ions not received by the substrate are ineffective in contributing any work in coating and puts additional and unnecessary load on the pumping system of the chamber.

The operational efficiency of the system can be increased by balancing the following system parameters/characteristics: The chamber working distance; the pumping speed (liters per minute/min); and the synchronous firing.

The working distance from the source 22 and or 31 to the substrate determines the mean free path desired for the system. For example, if the distance from the evaporative source to the substrate is 1 meter, the mean free path desired would commonly be 1 meter or greater. For example, a pressure of 5×10⁻⁴ torr would provide a mean free path of 10 centimeters, but a pressure of 5×10⁻⁵ torr would provide a mean free path of 1 meter. Thus, in the best case, with a working distance of 1 meter, the desired pressure would be 5×10⁻⁵ torr or less. In an alternative embodiment, the drive system 75 is capable of changing the working distance of system by moving the carrier 65 and substrates 61 and 60 up or down relative to the ion source 22 as illustrated in FIG. 4. In alternative embodiments, the working distance could be changed by moving the source 22 closer to or further away from the substrates 61 and 60.

The pumping speed of a system can differ from chamber to chamber depending on the design and maintenance of the chambers 50. For instance, if the system has a slow leak of 5 Standard Cubic Centimeters per Minute (SCCM), the pressure in the system can be raised considerably if the system does not have a high-vacuum, high-speed pump. An ion source 22 that is in full continuous operation could be considered a system leak. Some ion source models deliver 25-40 SCCM to a system making it difficult to maintain the low pressure desired for the operation. If the pumping speed in the system is constant, the gas load and the rate of evaporation of the material must be adjusted in order to maintain the correct pressure that allows the proper mean free path.

The problem of the constant gas load is that it burdens the high vacuum pumping system, raises the operating pressure and shortens the mean free path. These problems can be reduced with synchronous firing. Synchronous firing operates by feedback 86 from the substrate drive system 75 to the PLC 40 that indicates the location of the substrate target 60 and 61. Just before the arrival of the substrate 60 and/or 61 to the target zone, the ion source 22 would fire a burst of ions that is required to do the work on the substrate 60 or 61 surface. This burst of working gas synchronizes with the arrival of the substrate 60 or 61 to interact with the surface and limiting the gas load from the ion source 22. The pumping system can work to recover the lower operating pressure and maintain the longer mean free path. The synchronous feedback 86 from the drive mechanism will then send a signal to the PLC 40 for the next arrival of a substrate 61 or 60 into the work zone 71 and the firing of the ion source 22. This action is repeated continuously during the course of the coating operation. The overall gas load would then be an average between the burst of gas from the ion source 22 and the standby mode of the ion source 22.

With all of these factors taken into account, the optimum coating procedure can be determined. A program is started in the PLC 40 which opens and closes the valves at intervals dictated by the program. An RGA 32 makes a constant analysis of the partial pressures of individual gases in the chamber 50. This information is given to the PLC 40. If needed, the PLC 40 can make adjustments if needed, to the amount of gas supplied to the ion source 22 or chamber 50 based on the parameters of the program. The optimum ratio of gases in the gas mix is achieved by regulating the intervals of the opening and closing (and/or the degree of opening or closing) of the individual gas valves 10, 11, 12, 13.

For example, in the case of the evaporation of titanium dioxide there will be fluctuations in the concentration of oxygen. The PLC 40 will receive the information from the RGA 32 that the pressure of oxygen gas is changing and the response from the PLC 40 will change the timing and duration of the valve 10, 11, 12, 13 attached to the fresh source of oxygen 1, 2, 3, 4.

The invention has a wide variety of benefits and uses. Because this improved technology allows the creation of controlled thin-films and multiple thin-film layering many previously impossible and desirable results can be achieved. One proposed use would be in the area of microelectronic mechanical systems (MEMS). One of the limitations of previous technology is the inability to create complex layering of films in an acceptable overall thickness. Previously films would need to be deposited in thick layers due to the slow change of gas partial pressures. For instance, suppose it was desired to create a film with multiple layers with differing material properties such as a composite of 500 layers of carbon diamond like coating (DLC) (for thermal conductivity) alternating with 500 layers of silicon carbide (for strength). In this example with the proposed improvements it would be possible to create a 1 micron composite film with 1000 alternating layers creating a unique product with the properties of both a diamond like coating and silicon carbide: thermal conductivity and strength respectively. In an alternative embodiment, zirconium dioxide (thermally insulating) layers could be used instead of the carbon DLC (thermally conductive) layers. This material would have the thermal conductive properties of zirconium dioxide and the strength of silicon carbide. 1s With previous technology such composite films (silicon carbide/zirconium dioxide or silicon carbide/DLC) would be extremely difficult to build and would be prohibitively thick.

The invention allows for the use of reactive gases by using inert gas dilution to reducing corrosion. When using extremely reactive gasses, the reactivity can be reduced by dilution of an inert gas. For example, the extremely reactive gas, Fluorine, can be diluted with Helium to give better control of the reaction rate. The primary cylinder 1, 2, 3 or 4 can be Fluorine diluted with Helium and during the deposition; the PLC 40 will control dilution of the, gas mixture if necessary to further reduce reactivity. For example, a 10% mixture of Fluorine gas in Helium enters the ion source and has a duty cycle of 1 second. This is further diluted by Helium from another canister 1, 2, 3 or 4 with a duty cycle of 10 seconds. If it is determined that further reduction of reactivity is needed, this can be achieved by greater dilution with an increase in the duty cycle of the Helium.

In the field of optics it is common to use Argon in ion assisted deposition (IAD) to densify infrared films. The disadvantage of using Argon is that it results in damaged coatings with less than optimum optical quality due to the displacement of Fluorine on the coating. The damaged coating results in optical absorption. Therefore it is beneficial to use Fluorine in the ion source in creating infrared coatings as it is massive enough to create dense coatings and is able to replace any displaced Florine. Because of the difficulty of controlling this reactive gas, Fluorine has not typically been used in this application. Using this improved technology, Fluorine gases can be regulated and controlled in order to be used in such an application.

An immediate use would be the application of Calcium Fluoride as an antireflective coating. Without ion assisted deposition (IAD) the coating on a plastic substrate would easily be scraped off the surface of the plastic. Ion assisted deposition gives a durable coating but has a disadvantage of displacing the Fluorine and creating a metal rich coating with higher absorption. The use of Fluorine will give dense coatings with ion bombardment and replace Fluorine that may have been removed during bombardment.

In other embodiments in optical coatings is the desire to produce protective anti-scratch films on plastic substrate. An example would be a Polycarbonate lens that would be bombarded with Fluorine to activate the surface. Followed with the initial evaporation of a small amount of Aluminum that is bombarded with Oxygen ions. This would then form a complex composite layer that is an excellent adhesion layer. This type of composite bonding gives a unique layer that binds dissimilar materials and gives a durable bond.

This composite layer is the foundation for the final Aluminum oxide layer. This is achieved with continued evaporation of Aluminum and Oxygen ion bombardment. In the application of Diamond Like Coatings (DLC) the substrate which could be a polymer would be first cleaned with Argon ion bombardment. A small amount of Fluorine deposited from the ion source to activate the surface and create an adhesion layer, followed by evaporation of Silicon to form a Silicon Fluorine bond. The ion source would instantly change over to Methane and would start bombardment with Methane from the ion source to form a thin Silicon Carbide layer followed with continuous Methane bombardment to build a Diamond Like Coating layer. This is the formation of a complex composite layer and the advantage of this system is the infinite variability but with reproducibility.

In the application of polymers are the thin film membranes that can be modified with reactive ion bombardment. A hydrophilic membrane could be converted with Fluorine ion bombardment to a membrane with a hydrophobic outer layer on the impact side and a hydrophilic layer on the backside. The membrane could be supported on a cryogenically cooled surface to further reduce the heat from the exothermic Fluorine reaction. Other embodiments is the higher particle energy that can be used to drive the Fluorine into the interior or completely through the membrane. This could give various degrees of Fluorination of the film including Perfluorination of the polymer. This would have characteristics similar to Nafion made by DuPont which is used as a Fuel Cell membrane.

In other embodiments, a Fluorocarbon polymer which has a high dielectric constant is mounted on a cryogenically cooled support. This support is electrically biased with a probe on the front side (bombardment side) of the polymer. The Fluorocarbon film is then bombarded with high-energy particles of Oxygen that would pierce the membrane fracture the polymer backbone leaving a functional group. This would continue until the dielectric constant breaks down and is measured with the probe. The resulting product is a rugged inert Fluorocarbon film with functional groups which behave as portals for electron transport. This type film would have direct application in Fuel Cells.

The invention allows for a precisely controlled, repeatable schedule of variable gas mixes allowing for precise layer layment and manipulation in a controlled repeatable manner. Particularly when it is necessary for the layers in the coating design to be precise, it is desirable to have a repeatable process utilizing the finest increments of the different variables. Such incremental adjustments of the variables include rate of deposition, substrate temperature, speed of rotation of the substrate, amount and timing of the release of gas or gas mixture to the ion source. The PLC 40 regulates the program schedule for a specific design. The PLC 40 gives the system repeatability of design by controlling the above variables within the chamber.

The present invention also allows easy switching of like gas canisters significantly decreasing downtime to switch gas canisters thus reducing down time or wasted gas in partially filled canisters. When following a deposition program gas pressures are monitored at the inlet line of the gas cylinder or by monitoring the partial pressure within the chamber. When the primary gas cylinder is exhausted and the conditions do not meet the expected parameters for the program, the PLC 40 will signal a secondary (back-up) gas cylinder to be used. For example, a cylinder of Argon is being used in a program. If the primary cylinder of Argon is exhausted, the PLC 40 will activate the secondary cylinder of Argon gas.

The present invention automates repeatable runs of mixed gases based on ratios of gases using PLC control. After repeated production runs using the RGA 32, a history is buit with the proper gas ratios and conditions. Under ideal conditions repeated production runs build and established history and the mixed gasses can be run completely by the scheduled program without the use of a residual gas analyzer. However, conditions of a deposition chamber are rarely stable and real time analysis is recommended to provide compensation for any real time changes in the chamber. The PLC 40 analyzes the information received from the RGA 32 in real-time to ensure that the desired parameters of the program are met. However, if any of the conditions have changed, such as a change in pressure or temperature of the gas, the PLC can signal the valves to compensate the duty cycle to achieve the desired parameters.

While the present invention has been described with reference to particular embodiments, it may be understood that the embodiments are illustrative and that the inventions scope is not so limited. Any variations, modifications, additions and improvements to the embodiments described are possible. These variations, modifications, additions and improvements may fall within the scope of the invention as detailed within the following claims.

I claim:

1. A ion source gas delivery system comprising:
a) A chemical analyzer for measuring residual gas levels;
b) A controller for receiving residual gas levels and sending control signals to
c) A valve which controls the delivery of gas to an ion source.

2. The gas delivery system of claim 1 where:
a) A residual gas levels for a plurality of gasses are measured; and
b) the controller receives a plurality of residual gas level measurements and sends control signals to
c) a plurality of valves for controlling the delivery of a plurality of gases to the ion source.

3. The gas delivery system of claim 2 where one of the gases delivered to the ion source is Florine and another gas delivered to the ion source is an inert gas.

4. The gas delivery system of claim 3 where the inert gas is Helium.

5. The gas delivery system of claim 1 in which
a) the ion source generates a stream of ions, and
b) the controller also can receive information from a multi-substrate drive system which is used by the controller to synchronize the release of ions from the ion source with the appearance of substrates in the path of the ion stream.

6. The gas delivery system of claim 3 where the target of the ion source is a plastic.

7. The gas delivery system of claim 3 where the target of the ion source is a polycarbonate.

8. A method for delivering gas to an ion source including the following steps:
a) measuring the level of residual gas;
b) providing a controller with the measurements of the level of the residual gas;
c) sending control signals from the controller to valve controlling the release of gas to the ion source that affect the level of the measured residual gas.

9. The method of claim 8 where a plurality of residual gas levels are measured.

10. The method of claim 9 where control signals are sent to a plurality of gases that affect the level of the measured residual gases.

11. The method of claim 10 where the ion source is being used to produce a bonding layer on the surface of the plastic.

12. The method of claim 11 where a gas released to the ion source is Florine.

13. The method of claim 11 where a gas released to the ion source is a dilution of Florine.

14. The method of claim 11 where the gas released to the ion source is a dilution of Florine in an inert gas.

15. The method of claim 14 where the inert gas is Helium.

16. A product which at some point in its manufacture at lease some surface of the product was subject to surface treatment by an ion source where the delivery of gas to the ion source is controlled by a controller that receives information from a chemical analyzer that measures the levels of residual gases that are affected by the amount of a particular gas delivered to the ion source.

17. A product of claim 16 for which the treated surface was plastic.

18. A product of claim 16 for which the gas delivered to the ion source contains Florine.

19. A product of claim 16 for which:
a) treated surface was plastic;
b) the gas delivered to the ion source contains Florine.

20. A product of claim 18 for which after the surface was treated with Florine ions another coating where applied to the surface while continuing to be bombarded with Florine ions.
